(19) United States
(12) Patent Application Publication
(10) Pub. No.: US 2022/0080527 A1
(43) Pub. Date: Mar. 17, 2022

(54) Method for Laser Marking a Metallic Surface

(71) Applicant: Huf Technologies GmbH, Velbert (DE)

(72) Inventors: Mansour Ashtiani, Novi, MI (US); Patrick Christopher McGehee, Commerce Township, MI (US); Geoffrey Corbin, Grosse Pointe Farms, MI (US); Jeric Frank Foster, Chesaning, MI (US)

(73) Assignee: Huf Technologies GmbH, Velbert (DE)

(21) Appl. No.: 17/294,987

(22) PCT Filed: Nov. 20, 2019
(86) PCT No.: PCT/IB2019/059997

§ 371 Date: May 18, 2021

Related U.S. Application Data
(60) Provisional application No. 62/770,206, filed on Nov. 21, 2018.

(51) Int. Cl. B23K 26/359; B23K 26/00; B23K 26/06; B23K 26/0622; B23K 26/70; B41M 5/26

(52) U.S. Cl. CPC B23K 26/359; B23K 26/0006; B23K 26/0665; B23K 26/08; B23K 26/70; B41M 5/26; B23K 26/0622

(57) ABSTRACT

A method is provided for marking a location on a surface of a component. The location defines a normal extending perpendicularly therefrom. The method includes irradiating the location with a first laser beam to create a first mark having a first color. The first laser beam is disposed at a first angle relative to the normal. The method also includes irradiating the location with a second laser beam to create a second mark having a second color different than the first color. The second laser beam is disposed at a second angle relative to the normal. The second angle is different than the first angle.

### CROSS REFERENCE TO RELATED APPLICATIONS

This application is a National Phase Application which claims priority under 35 U.S.C. § 371 to Patent Cooperation Treaty Application No. PCT/IB2019/059997, filed Nov. 20, 2019, which claims priority to U.S. Provisional Patent Application Ser. No. 62/770,206, filed Nov. 21, 2018, the disclosures of which are hereby incorporated by reference in their entireties.

### FIELD

The present disclosure relates generally to a method for marking a surface of an object, and more particularly to a method for coloring a metallic surface of an object by applying a laser to the metallic surface.

### BACKGROUND

This section provides background information related to the present disclosure and is not necessarily prior art.

The outer surface of a part or component can be marked or colored using various methods and techniques. For example, the outer surface of a plastic part or component can be marked or colored by painting, molding with a coloring agent, printing, or irradiating with a laser. Similarly, the outer surface of a metal part, or the metallic outer surface of a part formed from a material other than metal, can be marked or colored by painting, printing, or irradiating with a laser. For example, U.S. Publication No. 2008/0139707 A1 describes a method for producing a multi-color laser marking on a molded article, while U.S. Pat. No. 6,313,436 describes a method for laser-marking the surface of a material by applying a coating to the surface and then irradiating the coating with a laser. While known methods for marking or coloring metallic surfaces of various components have proven acceptable for their intended purposes, a continuous need for improvement remains in the pertinent art.

### SUMMARY

This section provides a general summary of the disclosure, and is not a comprehensive disclosure of its full scope or all of its features.

One aspect of the disclosure provides a method for marking a location on a surface of a component. The location may define a normal extending perpendicularly therefrom. The method may include irradiating the location with a first laser beam to create a first mark having a first color. The first laser beam may be disposed at a first angle relative to the normal. The method may also include irradiating the location with a second laser beam to create a second mark having a second color different than the first color. The second laser beam may be disposed at a second angle relative to the normal. The second angle may be different than the first angle.

Implementations of the disclosure may include one or more of the following optional features. In some implementations, the first angle is greater than the second angle. In some implementations, the first angle is less than the second angle.

In some implementations, the first laser beam is generated by a laser source. The method may further include moving one of the component or the laser source relative to another of the component or the laser source while irradiating the location with the first laser beam. In some implementations, the method includes moving one of the component or the laser source relative to the other of the component or the laser source while irradiating the location with the second laser beam.

In some implementations, the first color includes a shade of gray or a shade of brown, and the second color includes a shade of blue.

In some implementations, the method includes defocusing the first laser beam.

In some implementations, the method includes removing a residue from the second mark. Removing the residue from the second mark may include applying alcohol or water to the surface.

In some implementations, the surface is formed at least in part from chrome.

Another aspect of the disclosure provides a method of laser marking. The method may include providing a component comprising an outer surface including a location having a first color. The method may also include irradiating the location with a first laser beam disposed at a first angle relative to a normal extending from the location to change the first color of the location to a second color. The method may also include irradiating the location with a second laser beam disposed at a second angle relative to the normal to change the second color of the location to a third color. The second angle may be different than the first angle.

This aspect may include one or more of the following optional features. In some implementations, the first angle is greater than the second angle. In some implementations, the first angle is less than the second angle.

In some implementations, the first laser beam is generated by a laser source. The method may further include moving one of the component or the laser source relative to another of the component or the laser source while irradiating the location with the first laser beam. In some implementations, moving one of the component or the laser source relative to the other of the component or the laser source while irradiating the location with the second laser beam.

In some implementations, the second color includes a shade of gray or a shade of brown, and the third color includes a shade of blue.

In some implementations, the method includes defocusing the first laser beam.

In some implementations, the method includes removing a residue from the location. Removing the residue from the location may include applying alcohol or water to the outer surface.

In some implementations, the outer surface is formed at least in part from chrome.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a schematic cross-sectional view of a component suitable for laser marking in accordance with the principles of the present disclosure;

FIG. 2 is a flowchart illustrating a method for marking a surface of a component in accordance with the principles of the present disclosure;

FIG. 3A is a schematic perspective view of a laser marking system in a first stage of operation in accordance with the principles of the present disclosure;

FIG. 3B is a schematic perspective view of the laser marking system of FIG. 3A in a second stage of operation in accordance with the principles of the present disclosure;

FIG. 3C is a schematic perspective view of the laser marking system of FIG. 3A in a third stage of operation in accordance with the principles of the present disclosure;

FIG. 4A is a schematic cross-sectional view of the laser marking system of FIG. 3A taken along the line 4A-4A; and

FIG. 4B is a schematic cross-sectional view of the laser marking system of FIG. 3B taken along the line 4B-4B.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

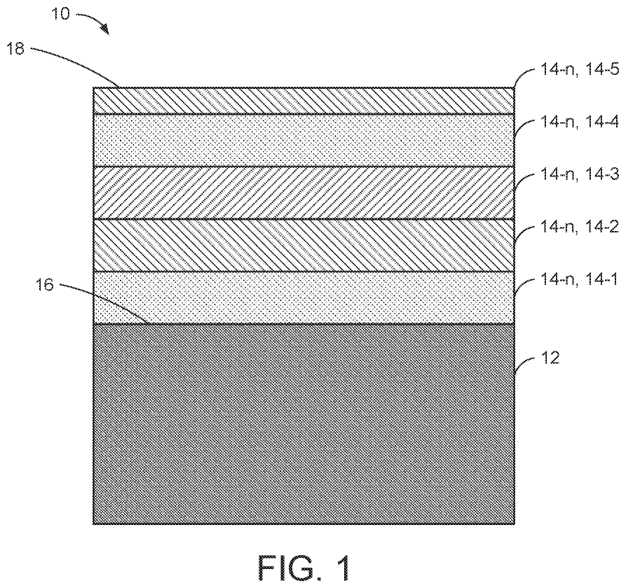

With reference to FIG. 1, a cross-sectional view of an exemplary component 10 for pulse-marking is illustrated. In some implementations, the component 10 may include an automotive door handle, an automotive trim piece, or an automotive decal. It will be appreciated, however, that the component 10 may include other types of components, including non-automotive components, within the scope of the present disclosure.

The component 10 may include a substrate 12 and one or more layers 14-1, 14-2, . . . 14-n of material. The layers 14-1, 14-2, . . . 14-n of material may be disposed on an outer surface 16 of the substrate 12, such that the component 10 includes an outermost surface 18. In particular, a first layer 14-1 of material may be directly disposed on the substrate 12, while additional layers 14-2, 14-3, . . . 14-n of material may be disposed on the first layer 14-1 of material or other ones of the additional layers 14-2, 14-3, . . . 14-n of material, such that the substrate 12 or one of the layers 14-1, 14-2, . . . 14-n includes the outermost surface 18 of the component 10. In this regard, while the component 10 is generally illustrated and described herein as including five layers 14-1, 14-2, . . . 14-n of material, such that a layer 14-5 includes the outermost surface 18, it will be appreciated that the component 10 may include more or less than five layers 14-1, 14-2, . . . 14-n of material within the scope of the present disclosure, such that the substrate 12 or one of the other layers 14-1, 14-2, . . . 14-n includes the outermost surface 18. In some implementations, one or more of the materials defining the layers 14-1, 14-2, . . . 14-n may include microporous characteristics. For example, one or more of the layers 14-1, 14-2, . . . 14-n may include a material having pores defining a diameter less than two nanometers.

In some implementations, the substrate 12 is composed of a plastic or metal substrate formed from one or more of nylon, brass, an acrylonitrile butadiene styrene (ABS), a polycarbonate/ABS composite (PC/ABS), or a zinc plate. The first layer 14-1 of material may be composed of nickel, or a nickel alloy, having a thickness of approximately 1 In some implementations, the first layer 14-1 includes a microporous nickel or nickel alloy material. A second layer 14-2 of material may be disposed on the first layer 14-1 of material and composed of chromium, or a chromium alloy, having a thickness of approximately 3 The third layer 14-3 of material may be disposed on the second layer 14-2 of material and composed of copper, or a copper alloy, having a thickness of approximately 20 The fourth layer 14-4 may be disposed on the third layer 14-3 and composed of nickel, or a nickel alloy having a thickness of approximately 15 The fifth layer 14-5 of material may be disposed on the fourth layer 14-4 of material and composed of chromium, or a chromium alloy (e.g., chromium-3 or chromium-6), having a thickness of approximately 0.5 In this regard, the total thickness of the layers 14-1, 14-2, . . . 14-n of material may be approximately 40 μm.

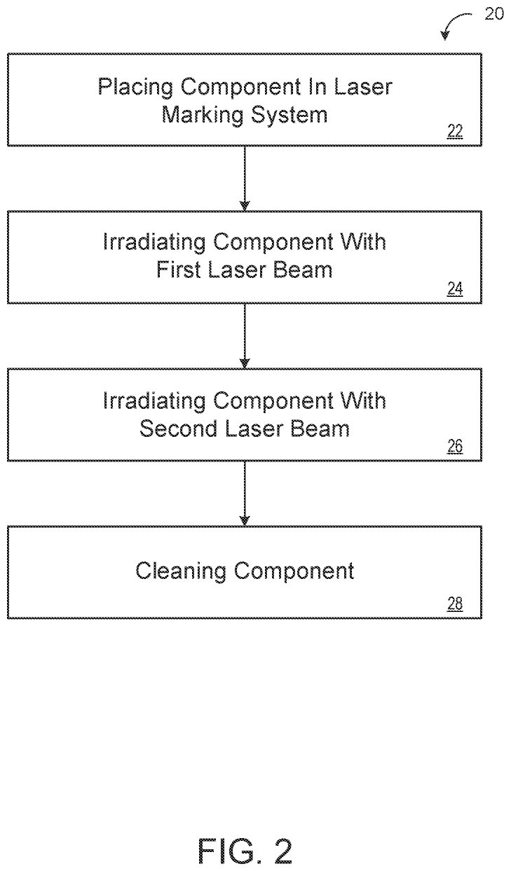

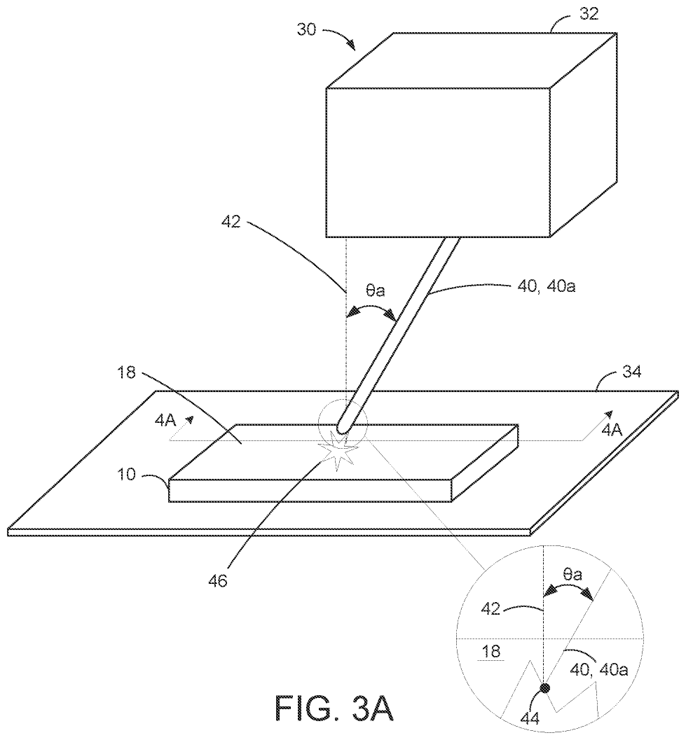

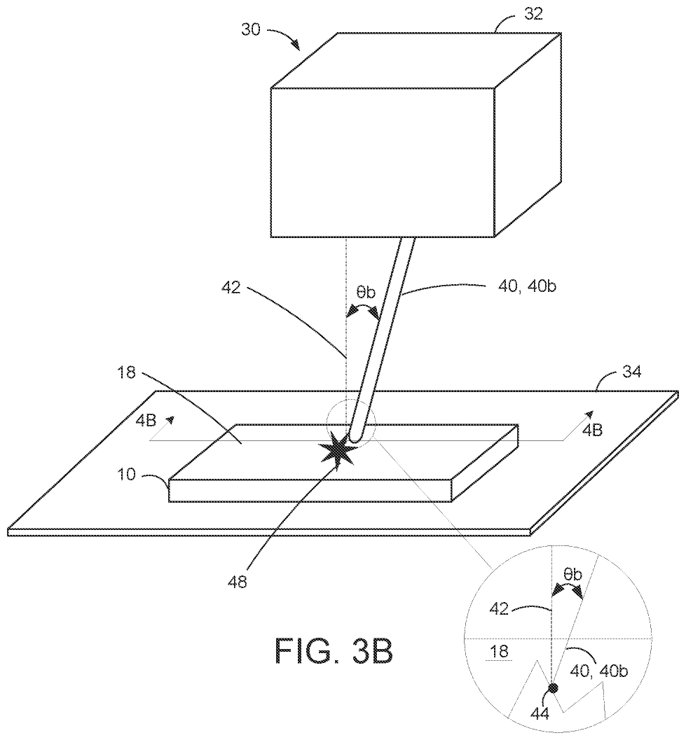

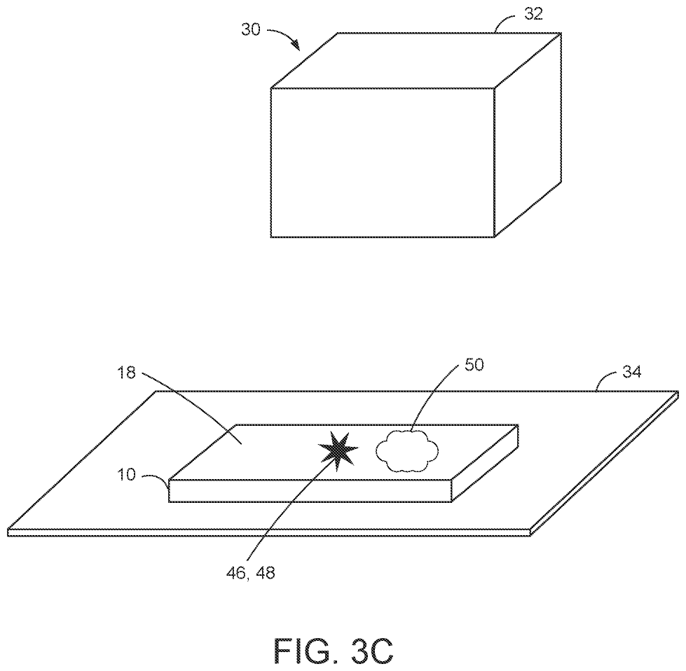

With reference to FIG. 2, a method 20 for laser-marking a component (e.g., component 10) is illustrated. As will be described, the method 20 may be implemented using a laser marking system 30 illustrated in FIGS. 3A-3C. The laser marking system 30 may include a laser source 32 and a support or stage 34 to support the component 10. A further discussion of the component 10 and the laser source 32, including various configurations and methods of use, may be found in commonly-owned U.S. Pat. No. 9,205,697 B2, entitled “Method for Color Marking Metallic Surfaces,” which is hereby incorporated by reference in its entirety.

As will be explained in more detail below, the laser source 32 may be configured to supply or generate a laser beam 40. In this regard, the laser source 32 may be referred to herein as the laser generator 32. In particular, as will be described in more detail below, the laser source 32 may generate one or more laser beams 40, and transmit the laser beams 40 to the component 10.

As illustrated in FIG. 2, at step 22, the method 20 may include placing a component (e.g., component 10) within a laser marking system (e.g., laser marking system 30). For example, with reference to FIG. 3A, at step 22, the method 20 may include placing the component 10 on the stage 34. In particular, the method 20 may include placing the outermost surface 18 of the component 10 within a transmission path of a laser beam 40 of the laser source 32.

At step 24, the method 20 may include irradiating a component (e.g., component 10) with a laser beam. In some implementations, the laser beam may include the laser beam 40 generated by a laser source (e.g., laser source 32). For example, with reference to FIG. 3A, at step 24, the method 20 may include transmitting a first laser beam 40a from the laser source 32 to the component 10. In particular, the method 20 may include transmitting the first laser beam 40a from the laser source 32 to the component 10, such that the laser beam 40a strikes the outermost surface 18 of the component 10. In some implementations, the laser beam 40a is a defocused laser beam. In this regard, the user may adjust the laser source 32 to defocus the laser beam 40a by a percentage (e.g., between 0% and 100%) to selectively produce a first color on the outermost surface 18 of the component.

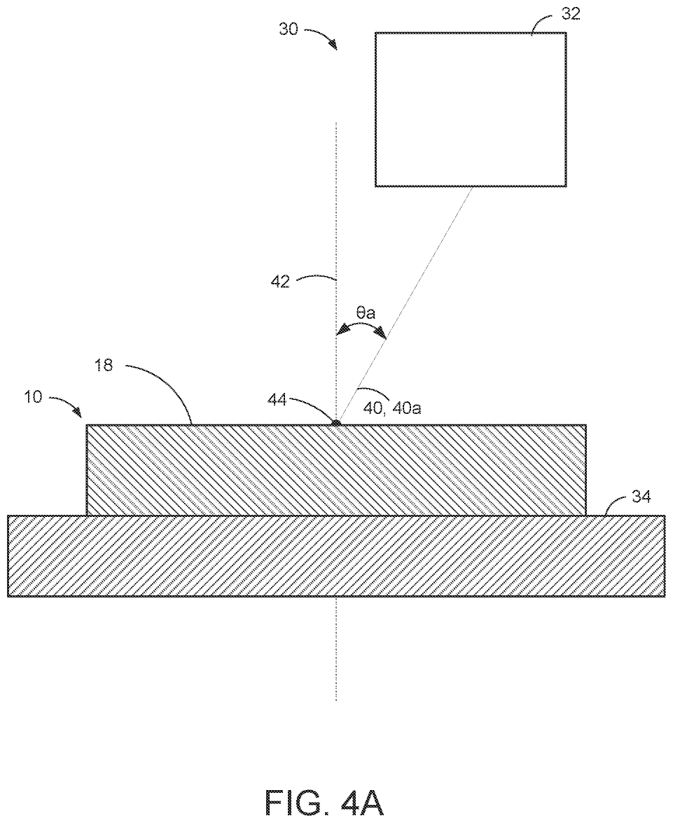

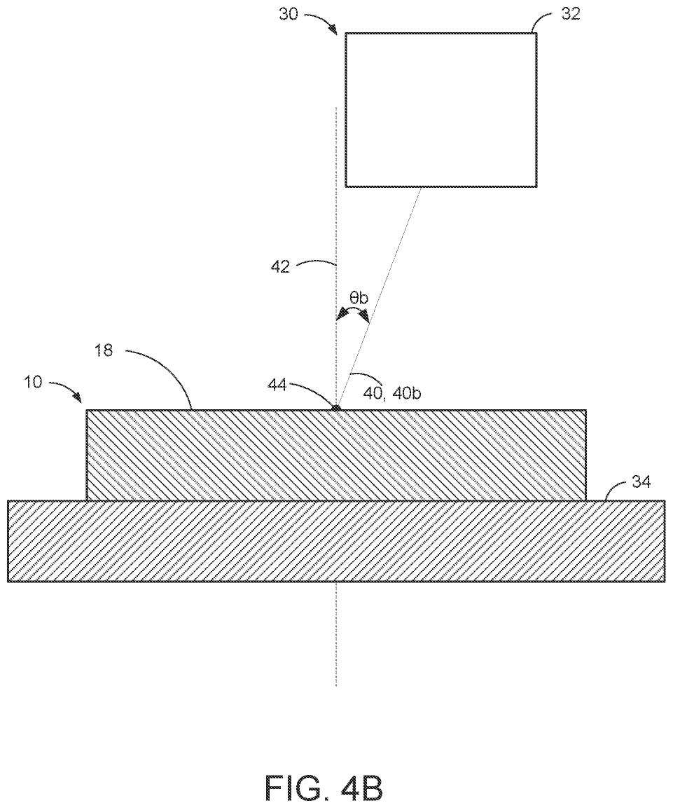

With reference to FIG. 4A, in some implementations, step 24 includes transmitting the laser beam 40a at an angle θa relative to a normal 42 of the outermost surface 18. The normal 42 may extend perpendicularly from a location 44 struck by the laser beam 40a, such that the laser beam 40a strikes and marks (e.g., changes the color of) the location 44, while preventing any marking of the remainder of the outermost surface 18. While the location 44 struck by a pulse of the laser beam 40a is generally shown and described herein as having a circular shape, it will be appreciated that the location may include, or otherwise define, other shapes within the scope of the present disclosure. For example, in some implementations, a cross-sectional dimension of the laser beam 40a, or the shape of the location 44 struck by a pulse of the laser beam 40a may define an oval shape in order to better control energy density of the laser beam 40a and more accurately control the characteristics of the mark created by the laser beam 40a at the location 44.

In some implementations, during step 24, at least one of the component 10 or the laser source 32 may move (e.g., translate or rotate) in one or more directions such that the location 44 struck by the laser beam 40a changes during step 24. Accordingly, the laser beam 40a may create a mark 46 having, or otherwise defined by, a plurality of locations 44 struck by the laser beam 40a on the outermost surface 18. In some implementations, the mark 46 produces, or otherwise defines, a first color (e.g., a light shade of brown or gray) on the outermost surface 18.

During step 24, at least one parameter of the laser source 32 may be selected or varied in order to select or vary a characteristic of the mark 46 created by the laser beam 40a at the location(s) 44. For example, in some implementations, a user may select or vary a level of heat input (Joules/mm²) of the laser beam 40a. In some implementations, a user may select or vary a marking speed (mm/second) of the laser beam 40a relative to the component 10. For example, the user may select the velocity at which either the component 10 or the laser source 32 moves (e.g., translates) relative to the other of the component 10 or the laser source 32. In some implementations, the user may select or vary the distance (μm) between adjacent locations 44 struck by the laser beam 40a. For example, the user may select or vary the distance between a first linear group of locations 44 and a second linear group of locations 44 that is adjacent (e.g., parallel) to the first linear group of locations. In particular, the laser beam 40a may create a first portion of the mark 46 defined by a first linear group of locations, and then create a second portion of the mark 46 defined by a second linear group of locations that is adjacent to, and offset from (e.g., in a direction perpendicular to the first or second linear group), the first linear group of locations 44. In some implementations, the user may select or vary a width or duration (nanoseconds) of the pulse of the laser beam 40a. For example, the user may allow the laser beam 40a to strike the location 44 for a predetermined duration. In some implementations, the user may select or vary the average power (Watts) of the laser beam 40a. In some implementations, the user may select or vary the repetition rate (kHz) of the laser beam 40a. For example, the user may allow the laser beam 40a to pulse a predetermined number of times per second. In some implementations, the user may select or vary the size (μm) of the location 44 struck by the laser beam 40a. For example, the user may select the diameter or other cross-sectional width of the laser beam 40a to select the size of the location 44 contacted by a pulse of the laser beam 40a. In this regard, by doubling the cross-sectional dimension of the laser beam 40a, the user may quadruple the area of the location 44, and reduce the intensity of the laser beam 40a by seventy-five percent.

As previously described, the laser beam 40a may create the mark 46 defining the first color (e.g., a light shade of brown or gray) on the outermost surface 18. In this regard, the appearance of the mark 46 may define the single, first color independent of an angle, orientation, or other characteristic (e.g., lighting) of the environment in which the mark 46 is viewed by an observer. For example, the mark 46 may produce the same, unique visual effect independent of the angle at which it is viewed, the lighting through or under which it is viewed, or the orientation of the mark 46 when it is viewed.

At step 26, the method 20 may include irradiating a component (e.g., component 10) with a laser beam. In some implementations, the laser beam may include the laser beam 40 generated by a laser source (e.g., laser source 32). For example, with reference to FIG. 3B, at step 26, the method 20 may include transmitting a second laser beam 40b from the laser source 32 to the component 10. In particular, the method 20 may include transmitting the second laser beam 40b from the laser source 32 to the component 10, such that the laser beam 40b strikes the outermost surface 18 of the component 10. In some implementations, the laser beam 40b is a defocused laser beam. In this regard, the user may adjust the laser source 32 to defocus the laser beam 40b by a percentage (e.g., between 0% and 100%) to selectively produce a second color on the outermost surface 18 of the component. While the method 20 is generally shown and described herein as including two steps 24, 26, it will be appreciated that the method 20 may include more or less than the two steps 24, 26 within the scope of the present disclosure. For example, the method 20 for laser-marking the component (e.g., component 10) may include multiple (e.g., two or more than two) steps within the scope of the present disclosure. In some implementations, the method 20 for laser-marking the component (e.g., component 10) includes twenty steps.

With reference to FIG. 4B, in some implementations, step 26 includes transmitting the laser beam 40b at an angle θb relative to the normal 42 of the outermost surface 18 such that the laser beam 40b strikes the location 44 on the outermost surface 18, thus allowing for marking (e.g., coloring) of the location 44 of the outermost surface 18, while preventing any marking of the remainder of the outermost surface 18.

In some implementations, during step 26, at least one of the component 10 or the laser source 32 may move (e.g., translate or rotate) in one or more directions such that the location 44 struck by the laser beam 40b changes during step 26. Accordingly, the laser beam 40b may create a mark 48 having, or otherwise defined by, a plurality of locations 44 struck by the laser beam 40b on the outermost surface 18. The mark 48 may product, or otherwise define, a second color (e.g., a dark shade of blue) that is different than the first color. In some implementations, the mark 48 is aligned with the mark 46, such that the laser beams 40a, 40b strike at least some of the same plurality of locations 44. In this regard, step 26 may include changing the color of the mark 46 from the first color to the second color.

During step 26, at least one parameter of the laser source 32 may be selected or varied in order to select or vary a characteristic of the mark 48 created by the laser beam 40b at the location(s) 44. For example, in some implementations, a user may select or vary a level of heat input (Joules/mm²) of the laser beam 40a. In some implementations, a user may select or vary a marking speed (mm/second) of the laser beam 40b relative to the component 10. For example, the user may select the velocity at which either the component 10 or the laser source 32 moves (e.g., translates) relative to the other of the component 10 or the laser source 32. In some implementations, the user may select or vary the distance (μm) between adjacent locations 44 struck by the laser beam 40b. For example, the user may select or vary the distance between a first linear group of locations 44 and a second linear group of locations 44 that is adjacent (e.g., parallel) to the first linear group of locations. In particular, the laser beam 40b may create a first portion of the mark 48 defined by a first linear group of locations, and then create a second portion of the mark 48 defined by a second linear group of locations that is adjacent to, and offset from (e.g., in a direction perpendicular to the first or second linear group), the first linear group of locations 44. In some implementations, the user may select or vary a width or duration (nanoseconds) of the pulse of the laser beam 40b. For example, the user may allow the laser beam 40b to strike the location 44 for a predetermined duration. In some implementations, the user may select or vary the average power (Watts) of the laser beam 40b. In some implementations, the user may select or vary the repetition rate (kHz) of the laser beam 40b. For example, the user may allow the laser beam 40b to pulse a predetermined number of times per second. In some implementations, the user may select or vary the size (μm) of the location 44 struck by the laser beam 40b. For example, the user may select the diameter or other cross-sectional width of the laser beam 40b to select the size of the location 44 contacted by a pulse of the laser beam 40b. In this regard, by doubling the cross-sectional dimension of the laser beam 40b, the user may quadruple the area of the location 44, and reduce the intensity of the laser beam 40b by seventy-five percent.

In some implementations, the angle θb is different than the angle θa. For example, the angle θa may define a first value between zero degrees and eighty-nine degrees, while the angle θb may define a second value, different than the first value, between zero degrees and eighty-nine degrees. In some implementations, the first value of the angle θa is between two degrees and ten degrees different (e.g., less than or greater than) than the second value of the angle θb.

As previously described, the laser beam 40b may create the mark 48 defining the second color (e.g., a dark shade of blue) on the outermost surface 18. In this regard, the appearance of the mark 48 may define different second colors depending on an angle, orientation, or other characteristic (e.g., lighting) of the environment in which the mark 48 is viewed by an observer. For example, the mark 48 may produce (i) a first unique visual effect (e.g., color) when viewed at a first angle, a first orientation, or under first lighting conditions, and (ii) a second unique visual effect (e.g., color), different than the first unique visual effect, when viewed at a second angle, a second orientation, or under second lighting conditions that is or are different than the first angle, the first orientation, or the first lighting conditions. In this regard, the mark 48 may simultaneously produce the first and second unique and different visual effects when viewed under one or more different conditions (e.g., viewing angle, orientation, lighting conditions, etc.). As previously discussed, while the method 20 is generally shown and described herein as including two steps 24, 26, it will be appreciated that the method 20 may include more or less than the two steps 24, 26 within the scope of the present disclosure. For example, the method 20 for laser-marking the component (e.g., component 10) may include multiple (e.g., two or more than two) steps of marking the surface 18 with a laser beam in order to create marks having a plurality of visual effects within the scope of the present disclosure.

At step 28, the method 20 may include cleaning a component (e.g., the component 10). For example, with reference to FIG. 3C, at step 28, the method 20 may include placing a suitable substance 50 (e.g., water, alcohol (e.g., isopropyl alcohol), etc.) on the outermost surface 18 of the component 10 to remove any soot or other residue created during step 26 or step 28. In particular, the method 20 may include wiping the substance 50 on and over the marks 46, 48 of the outermost surface 18 to remove any residue created by the laser beams 40a, 40b at steps 24, 26.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method of marking a location on a surface of a component, the location defining a normal extending perpendicularly therefrom, the method comprising:
irradiating the location with a first laser beam to create a first mark having a first color, the first laser beam disposed at a first angle relative to the normal; and
irradiating the location with a second laser beam to create a second mark having a second color different than the first color, the second laser beam disposed at a second angle relative to the normal, the second angle being different than the first angle.

2. The method of claim 1, wherein the first angle is greater than the second angle.

3. The method of claim 1, wherein the first angle is less than the second angle.

4. The method of claim 1, wherein the first laser beam is generated by a laser source, the method further comprising moving one of the component or the laser source relative to another of the component or the laser source while irradiating the location with the first laser beam.

5. The method of claim 4, further comprising moving one of the component or the laser source relative to the other of the component or the laser source while irradiating the location with the second laser beam.

6. The method of claim 1, wherein the first color includes a shade of gray or a shade of brown, and the second color includes a shade of blue.

7. The method of claim 1, further comprising defocusing the first laser beam.

8. The method of claim 1, further comprising removing a residue from the second mark.

9. The method of claim 8, wherein removing the residue from the second mark includes applying alcohol or water to the surface.

10. The method of claim 1, wherein the surface is formed at least in part from chrome.

11. A method of laser marking comprising:
providing a component comprising an outer surface including a location having a first color;
irradiating the location with a first laser beam disposed at a first angle relative to a normal extending from the location to change the first color of the location to a second color; and
irradiating the location with a second laser beam disposed at a second angle relative to the normal to change the second color of the location to a third color, the second angle being different than the first angle.

12. The method of claim 11, wherein the first angle is greater than the second angle.

13. The method of claim 11, wherein the first angle is less than the second angle.

14. The method of claim 11, wherein the first laser beam is generated by a laser source, the method further comprising moving one of the component or the laser source relative to another of the component or the laser source while irradiating the location with the first laser beam.

15. The method of claim 14, further comprising moving one of the component or the laser source relative to the other of the component or the laser source while irradiating the location with the second laser beam.

16. The method of claim 11, wherein the second color includes a shade of gray or a shade of brown, and the third color includes a shade of blue.

17. The method of claim 11, further comprising defocusing the first laser beam.

18. The method of claim 11, further comprising removing a residue from the location.

19. The method of claim 18, wherein removing the residue from the location includes applying alcohol or water to the outer surface.

20. The method of claim 11, wherein the outer surface is formed at least in part from chrome.
